(19) United States
(12) Patent Application Publication
(10) Pub. No.: US 2024/0275625 A1
(43) Pub. Date: Aug. 15, 2024

(54) INFORMATION PROCESSING DEVICE, INFORMATION PROCESSING METHOD, AND PROGRAM

(71) Applicant: Sony Group Corporation, Tokyo (JP)

(72) Inventors: Nobuaki KAWAI, Kanagawa (JP); Yutaka TAKASE, Kanagawa (JP)

(73) Assignee: Sony Group Corporation, Tokyo (JP)

(21) Appl. No.: 18/569,538

(22) PCT Filed: Mar. 8, 2022
(86) PCT No.: PCT/JP2022/010090

§ 371 Date: Dec. 12, 2023

(30) Foreign Application Priority Data
Jul. 1, 2021 (JP) 2021-110300

(51) Int. Cl. H04L 12/18

(52) U.S. Cl. CPC H04L 12/1822; H04L 12/1818

(57) ABSTRACT

An information processing device includes: an individual identifying information acquisition unit that acquires individual identifying information regarding a target user from another information processing device; a partner user selection unit that selects, in a case where the target user has been determined to be able to communicate on the basis of user information regarding the target user identified as an individual, a partner user who is a communication partner of the target user from among other users determined to be able to communicate; and a start control unit that starts communicative telecommunication between the target user and the partner user.

### TECHNICAL FIELD

The present technology relates to a technical field of an information processing device, an information processing method, and a program that perform processing for achieving communication between users.

### BACKGROUND ART

Online communication in private or business has been increasingly promoted. Such communication requires a tool to be used and adjustment of date and time in advance.

In communication using a tool, personal information is registered in advance, and a user is identified as an individual by performing a login operation or the like at the time of use. Then, in order to communicate with a desired user using a tool, it is necessary to perform various operations on the tool, and it is necessary to fully use the tool.

Patent Document 1 below discloses a technology of determining a user to be connected by selecting a desired partner from a displayed image of the user using line-of-sight detection.

### CITATION LIST

### Patent Document

Patent Document 1: WO 2008/105252

### SUMMARY OF THE INVENTION

### Problems to be Solved by the Invention

However, in the technology described in Patent Document 1, although the burden on the user can be reduced by simplifying the operation, it is necessary to select the user who is to be the communication partner by his/her own will.

Therefore, it is difficult to perform accidental communication such as that caused by a chance meeting with a colleague while working in a company.

The present technology has been made in view of such a problem, and an object thereof is to provide accidental communication to a user.

### Solutions to Problems

An information processing device according to the present technology includes: an individual identifying information acquisition unit that acquires individual identifying information regarding a target user from another information processing device; a partner user selection unit that selects a partner user who is a communication partner of the target user from among other users determined to be able to communicate in a case where the target user is determined to be able to communicate on the basis of user information regarding the target user identified as an individual; and a start control unit that starts communicative telecommunication between the target user and the partner user.

The user information is, for example, schedule information, posture information, or the like. By determining whether or not communication is possible on the basis of the user information, a partner user is automatically selected and communicative telecommunication is started in a case where, for example, a state of being able to communicate is achieved.

### BRIEF DESCRIPTION OF DRAWINGS

FIG. 1 is a schematic diagram illustrating a configuration example of a communication providing system.

FIG. 2 is a block diagram illustrating an example of a functional configuration of a control unit of a client device.

FIG. 3 is a block diagram illustrating an example of a functional configuration of a control unit of a server device.

FIG. 4 is a schematic diagram illustrating an example of a room including a client-side system.

FIG. 5 is a flowchart illustrating an example of processing executed in the client-side system.

FIG. 6 is a flowchart illustrating an example of processing executed in the client-side system.

FIG. 7 is a flowchart illustrating an example of processing executed in a server-side system.

FIG. 8 is a flowchart illustrating an example of partner user search processing.

FIG. 9 is a flowchart illustrating an example of status update processing.

FIG. 10 is a flowchart illustrating another example of processing executed in the server-side system.

FIG. 11 is a flowchart illustrating an example of participable community search processing.

FIG. 12 is a diagram illustrating an example of a relationship between users.

FIG. 13 is a diagram illustrating another example of a room including the client-side system.

FIG. 14 is a block diagram of a computer device.

### MODE FOR CARRYING OUT THE INVENTION

Hereinafter, embodiments according to the present technology will be described in the following order with reference to the accompanying drawings.

<1. System Configuration>

<2. Processing in Client Device>

<3. Processing in Server Device>

<4. Another Example of Processing in Server Device>

<5. Modifications>

<6. Computer Device>

<7. Conclusion>

<8. Present Technology>

### 1. System Configuration

A communication providing system 1 according to the present embodiment will be described with reference to the attached drawings.

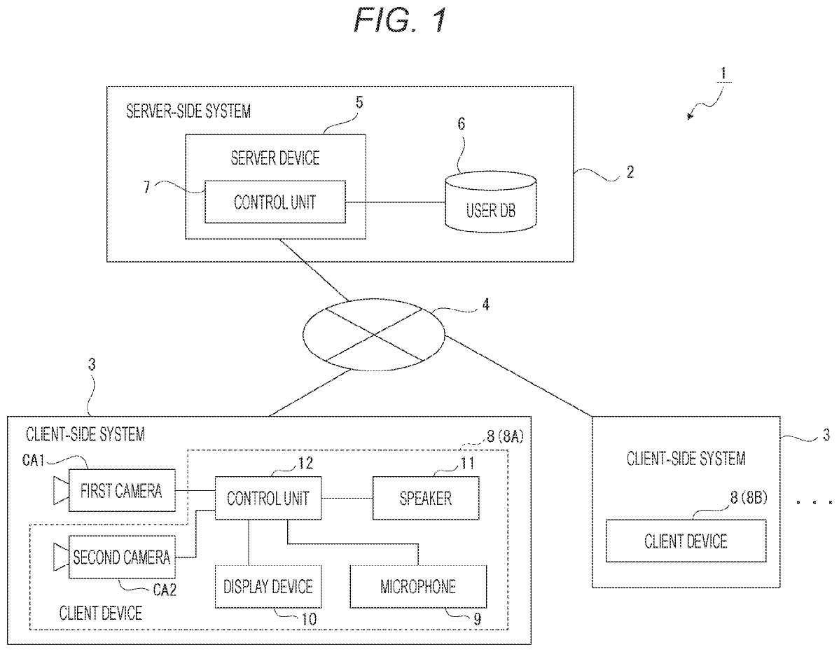

As illustrated in FIG. 1, the communication providing system 1 includes a server-side system 2 and a client-side system 3.

A plurality of client-side systems 3 is connected to allow mutual telecommunication to one server-side system 2 via a telecommunication network 4. Note that a plurality of server-side systems 2 may be provided.

The server-side system 2 includes a server device 5 and a user DB 6.

The server-side system 2 provides the user with a communication environment with other users by cooperating with various information processing devices included in the client-side system 3. Specifically, by matching users who use the information processing device of the client-side system 3, telecommunication for achieving accidental communication between the users (hereinafter referred to as “communicative telecommunication”) is performed.

Here, the accidental communication is a kind of communication that occurs accidentally, such as communication performed between colleagues of a company who accidentally get together at a company kitchenette, and does not correspond to communication such as a meeting where a time is predetermined.

That is, users who use the communication providing system 1 are automatically selected and matched without mutually designating the other user, whereby accidental communication occurs.

The server device 5 includes a control unit 7, and the control unit 7 realizes various functions by executing a program. This will be specifically described later.

The user DB 6 is an information processing device that stores information regarding users who use various functions provided by the communication providing system 1.

The client-side system 3 includes a client device 8 and a first camera CA1. The client-side system 3 is provided in correspondence with a specific room or a specific space.

Note that a plurality of client-side systems 3 may be provided for one specific room R.

The first camera CA1 is provided as an imaging device for monitoring a person entering a specific room R. The captured image data captured by the first camera CA1 is output to the client device 8.

The client device 8 is an information processing device used by a user who wants to accidentally communicate with other users. In other words, the user uses the client device 8 without determining the user to be the communicative telecommunication partner.

The client device 8 performs processing of detecting a posture or the like of the user who uses the client device 8, processing of transmitting captured image data or audio data of the user to the server-side system 2, and the like.

In the following description, a user who uses the client device 8 will be referred to as a “target user”. Furthermore, another user as the communication partner of the target user is described as a “partner user”.

Note that the partner user uses the client device 8 different from the client device 8 used by the target user. In the following description, a terminal device used by a target user will be referred to as a “client device 8A”, and a terminal device used by a partner user will be referred to as a “client device 8B”. However, in a case where no distinction is made as to users to use, the terminal device is simply described as “client device 8”

The client device 8A includes a second camera CA2, a microphone 9, a display device 10, a speaker 11, and a control unit 12.

The second camera CA2 is an imaging device that captures an image of a predetermined position. For example, the second camera CA2 captures an image of the target user in a state of sitting on a predetermined position, and outputs captured image data obtained by the capturing to the control unit 12.

The microphone 9 is a device that collects the speech voice and the environmental sound of the target user, and outputs an acoustic signal obtained by the sound collection to the control unit 12.

The display device 10 is a device that performs various displays for the target user. Specifically, the display device 10 displays, for the target user, a menu screen, a face image of the partner user, text information indicating chat content, and the like.

The speaker 11 is a sound reproduction device that reproduces the speech voice of the partner user and the environmental sound regarding the partner user.

The client device 8B has a configuration similar to that of the client device 8A. However, all the configurations may not be the same. For example, a part of the configuration may not be provided, or the configuration may be different such that the client device 8A includes earphones as the speaker 11, whereas the client device 8B includes headphones as the speaker 11.

Various configurations of the telecommunication network 4 can be considered. For example, the Internet, an intranet, an extranet, a local area network (LAN), a community antenna television (CATV) telecommunication network, a virtual private network, a telephone line network, a mobile telecommunication network, a satellite telecommunication network, and the like are assumed as the telecommunication network 4.

Furthermore, various examples are also assumed for transmission media constituting the whole or a part of the telecommunication network 4. For example, the present technology can be used in a wired manner such as Institute of Electrical and Electronics Engineers (IEEE) 1394, a universal serial bus (USB), power line conveyance, or a telephone line, or in a wireless manner such as infrared rays such as infrared data association (IrDA), Bluetooth (registered trademark), 802.11 radio, a mobile phone network, a satellite line, or a terrestrial digital network.

A functional configuration of the client device 8 will be described.

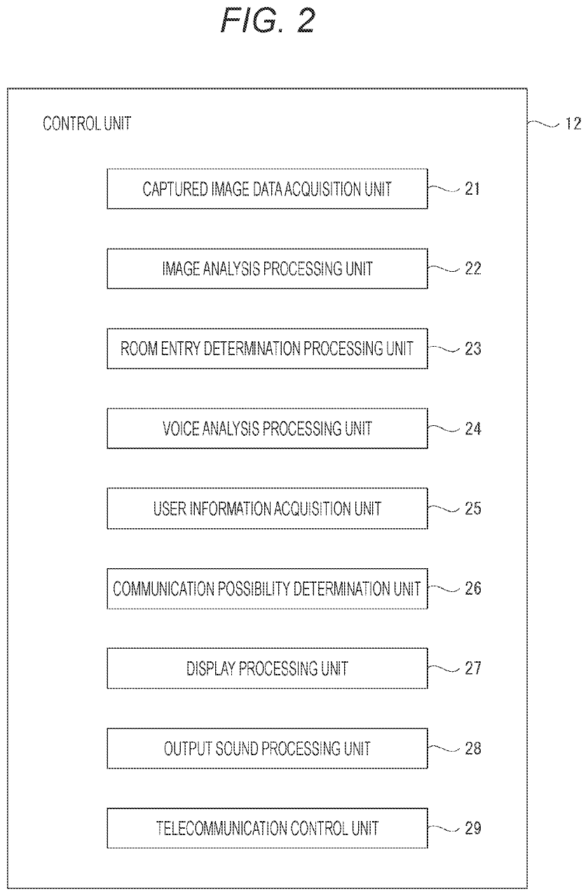

The client device 8 realizes various functions illustrated in FIG. 2 by the control unit 12 executing a program.

Specifically, the client device 8 includes a captured image data acquisition unit 21, an image analysis processing unit 22, a room entry determination processing unit 23, a voice analysis processing unit 24, a user information acquisition unit 25, a communication possibility determination unit 26, a display processing unit 27, an output sound processing unit 28, and a telecommunication control unit 29.

The captured image data acquisition unit 21 acquires first captured image data and second captured image data output from the first camera CA1 and the second camera CA2. The first captured image data output from the first camera CA1 is used for the room entry determination processing of the user.

Furthermore, the second captured image data output from the second camera CA2 is used for posture detection or face detection of the target user or conversation detection with another person.

The image analysis processing unit 22 performs image analysis processing on the first captured image data and the second captured image data.

Specifically, the image analysis processing unit 22 performs person detection by image analysis processing on the first captured image data. Furthermore, the image analysis processing unit 22 calculates position coordinates of the detected person in a three-dimensional space.

Note that the image analysis processing unit 22 may perform face detection of the detected person. The result of the face detection is used for the room entry determination processing in the room entry determination processing unit 23.

The image analysis processing unit 22 performs posture detection of the target user by image analysis processing on the second captured image data. The posture of the target user detected by the image analysis processing unit 22 is referred to as “posture information”. The posture information is, for example, three-dimensional coordinate information of the head, the chest, the elbows, the hands, the waist, the knees, and the ankles of the target user.

Furthermore, the image analysis processing unit 22 determines whether or not the target user is talking with another person by image analysis processing on the second captured image data. The term “another person” as used herein refers to a person other than the partner user who is performing communication by using the communication providing system 1. Also in the following description, in a case where the term “another person” is described, it refers to a person other than the partner user described above.

For example, in a case where the target user and a person other than the target user are detected in the second captured image data, and it is possible to estimate that the target user and other users are having a conversation from the direction of the face, the motion of the mouth, and the like, it is determined that the target user is having a conversation with another person.

Alternatively, in a case where it is detected that the target user is talking on a mobile phone, it may be determined that the target user is in conversation with another person.

The room entry determination processing unit 23 performs room entry determination processing of determining whether or not a person within an angle of view intends to enter the room R on the basis of the first captured image data output from the first camera CA1 installed near the entrance of the room R.

Specifically, the movement trajectory of the person is calculated using the time-series data of the detection result of the person by the image analysis processing unit 22 and the calculation result of the position coordinates in the three-dimensional space, and the estimated movement trajectory of the person is calculated from the movement trajectory.

The room entry determination processing unit 23 estimates whether or not a person enters the room R according to the estimated movement trajectory.

Note that the room entry determination processing unit 23 may perform the room entry determination processing using information of the direction of the face or the direction of the line-of-sight of the person detected on the basis of the first captured image data.

The voice analysis processing unit 24 detects a conversation between the target user and another person by analyzing an acoustic signal input via the microphone 9. This detection result is used in communication possibility determination processing to be described later.

The user information acquisition unit 25 performs processing of acquiring information regarding the target user identified as an individual in the server-side system 2. The user information about the target user is stored in the user DB 6 included in the server-side system 2.

The user information stored in the user DB 6 includes, for example, attribute information such as user identification (ID), name, age, gender, and the like, history information of communicative telecommunication with other users, group information to which the user belongs, seat information of the user, schedule information of the user, and the like.

The group information to which the user belongs is, for example, information of a company in which the user is present, a department or a development group organized in the company, or the like. These pieces of information are used to estimate the closeness of the social distance between the users.

Furthermore, for example, in a case of a company, the user's seat information is information regarding a seat position in the company. The seat information is used to estimate closeness of a physical distance between users in daily life.

Information indicating closeness of a social distance or closeness of a physical distance, such as group information and seat information, is described as “relationship information”.

The communication possibility determination unit 26 performs processing of determining whether or not communicative telecommunication can be performed for the target user on the basis of the user information of the target user or the like.

The user information used for the possibility determination may include not only information stored in the user DB 6 but also information indicating an analysis result for the user.

Specifically, not only the schedule information stored in the user DB 6, but also posture information regarding the user obtained as a result of performing the image analysis processing using the second captured image data captured by the second camera CA2, information indicating the presence or absence of a conversation with another person obtained as a result of performing the voice analysis processing, and the like are used as the user information used for the communication possibility determination.

For example, in a case where a state in which the target user is talking with another person has been detected, in a case where the posture of the target user is not a specific posture, in a case where a meeting or the like to be started within the most recent predetermined time in which the target user is planned to participate is set, or the like, the communicative telecommunication is determined to be impossible.

The specific posture is, for example, a state of facing the front in a state of sitting on a chair and directing the line-of-sight to the display device 10. In other words, a state in which the user is standing without sitting on a chair, a state in which the user is operating the mobile phone even if the user is sitting on a chair, or the like is determined not to be a specific posture.

Note that it may be determined that communicative telecommunication is possible in a case where a specific gesture is detected instead of a specific posture.

Furthermore, a seating sensor may be provided on the chair, and it may be detected that the target user is seated on the chair on the basis of an output signal of the seating sensor to determine whether or not communication is possible.

The display processing unit 27 performs processing of causing the display device 10 to display a predetermined image. As described above, the predetermined image is an image such as a menu screen, a face image of a partner user, or a chat screen including text information indicating chat content.

The output sound processing unit 28 performs sound reproduction for the target user by outputting a voice signal of the partner user, a signal regarding a system voice, and the like to the speaker 11.

The telecommunication control unit 29 performs data telecommunication with the server-side system 2 and another client-side system 3 via the telecommunication network 4.

A functional configuration of the server device 5 will be described.

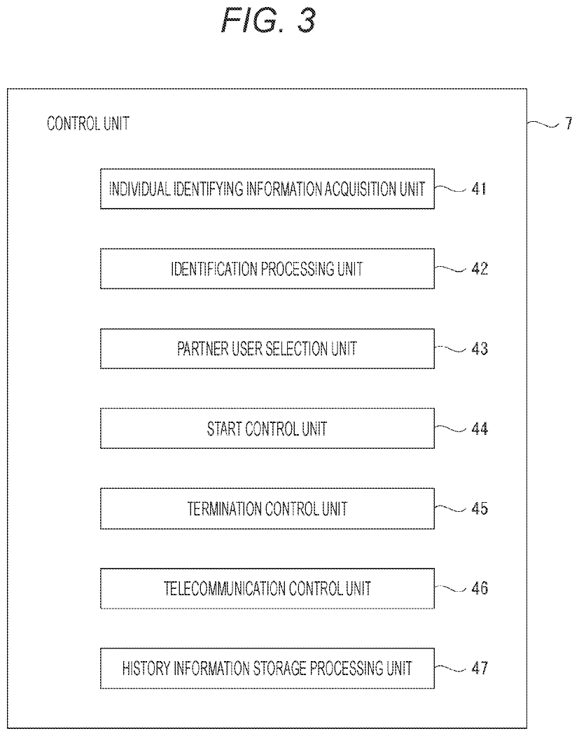

The server device 5 realizes various functions illustrated in FIG. 3 by the control unit 7 executing a program.

Specifically, the control unit 7 includes an individual identifying information acquisition unit 41, an identification processing unit 42, a partner user selection unit 43, a start control unit 44, a termination control unit 45, a telecommunication control unit 46, and a history information storage processing unit 47. The individual identifying information acquisition unit 41 acquires individual identifying information regarding the target user from the client-side system 3. Here, the individual identifying information will be described. The individual identifying information indicates information for identifying the target user as an individual and result information of individual identification.

Specifically, captured image data used for individual identification, such as captured image data obtained by capturing an image of the target user, acoustic data generated on the basis of a speech voice of the target user, fingerprint data, and the like are information for individual identification of the target user.

Furthermore, information that is obtained by individual identification of the target user and can uniquely identify the target user, for example, information such as a user ID, a name, an employee number, and the like is set as result information of the individual identification of the target user.

Note that the individual identifying information acquisition unit 41 may be configured to acquire user information of a user estimated to intrude into a specific room or a specific space. In other words, in a case where intrusion into a specific room or a specific space is not predicted, the user information may not be acquired.

The identification processing unit 42 executes individual identification processing for identifying the target user as an individual on the basis of the individual identifying information. Specifically, in a case where the individual identifying information acquisition unit 41 acquires information for identifying the target user as an individual, such as captured image data or the like, the identification processing unit 42 receives the information and executes the individual identification processing.

Note that, in a case where the individual identifying information acquisition unit 41 receives the result information of the individual identification from the client-side system 3, the individual identification processing by the identification processing unit 42 is not executed because the target user has been identified as an individual.

The partner user selection unit 43 performs processing of selecting a partner user on the basis of the user information of the target user identified as an individual.

For example, the partner user selection unit 43 selects the partner user on the basis of the relationship information with the target user. By selecting a user close to the target user as a partner user on the basis of the relationship information, it is possible to perform communicative telecommunication that simulates communication close to accidental communication that actually occurs.

Alternatively, the partner user selection unit 43 may select a user having a large history of communicative telecommunication with the target user as the partner user. In a case where the partner user is selected on the basis of the relationship information with the target user, a user closer to the target user is more likely to be selected as the partner user. Therefore, by selecting the partner user on the basis of the history of the communicative telecommunication, a user close to the target user can be selected as the partner user without executing the processing of selecting the partner user using the relationship information each time.

The start control unit 44 starts communicative telecommunication between the client device 8A used by the target user and the client device 8B used by the partner user selected by the partner user selection unit 43.

In a case where it is determined that the termination condition of the communicative telecommunication is satisfied, the termination control unit 45 terminates the communicative telecommunication performed between the client device 8A and the client device 8B.

Various termination conditions are conceivable. For example, it is determined that the termination condition is satisfied in a case where the set start time of the meeting is approaching within a predetermined time with reference to the schedule information of the target user and the partner user.

Alternatively, it is determined that the termination condition is satisfied in a case where a conversation with another person is detected for the target user or the partner user, that is, in a case where a state in which the target user or the partner user is actually spoken to by someone is detected.

Furthermore, it may be determined that the termination condition is satisfied in a case where it is determined that voice is produced by talking on a mobile phone with another person.

The telecommunication control unit 46 performs data telecommunication with the client-side system 3 via the telecommunication network 4.

The history information storage processing unit 47 performs processing of storing history information of communicative telecommunication in the user DB 6. The history information of the communicative telecommunication includes information for identifying the target user and the partner user, date and time information of the communicative telecommunication, chat content, voice data, and the like.

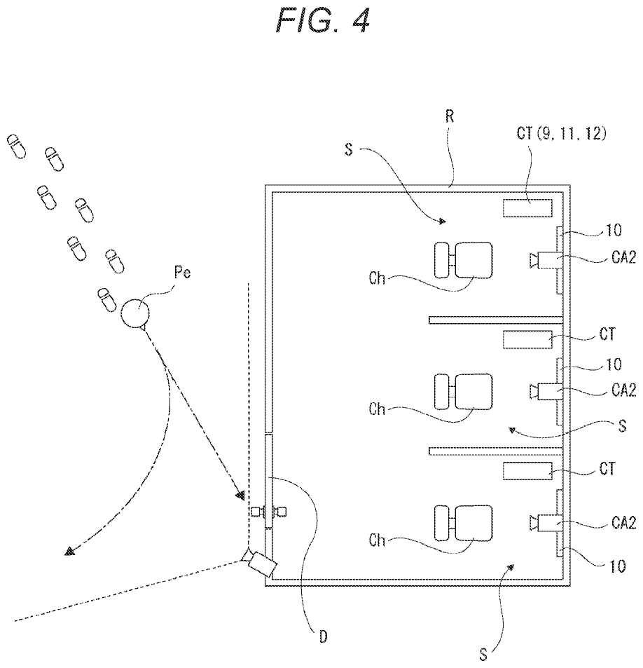

An example of the client-side system 3 and the room R in which the client-side system 3 is installed will be described with reference to FIG. 4.

The room R is provided as one room in which a door D is disposed, and three target spaces S are provided inside.

The client device 8 is installed in each target space S. FIG. 4 illustrates a client terminal CT including the microphone 9, the speaker 11, and the control unit 12 included in the client device 8, the second camera CA2, and the display device 10.

Furthermore, a chair Ch on which the target user can sit is installed for each target space.

The target user can perform communicative telecommunication by selecting one target space S and sitting on the chair Ch after entering the room R.

Furthermore, near the door D provided at the entrance of the room R, the first camera CA1 capable of capturing an image of a person who intends to enter the room R is installed.

The room entry determination processing unit 23 of the client device 8 determines, on the basis of the estimated movement trajectory of a person Pe indicated by a one-dot chain line in FIG. 4, whether or not the person is likely to enter the room R.

Note that it is only required that the room entry determination processing unit 23 is included in any of the three client devices 8 illustrated in FIG. 4.

### 2. Processing in Client Device

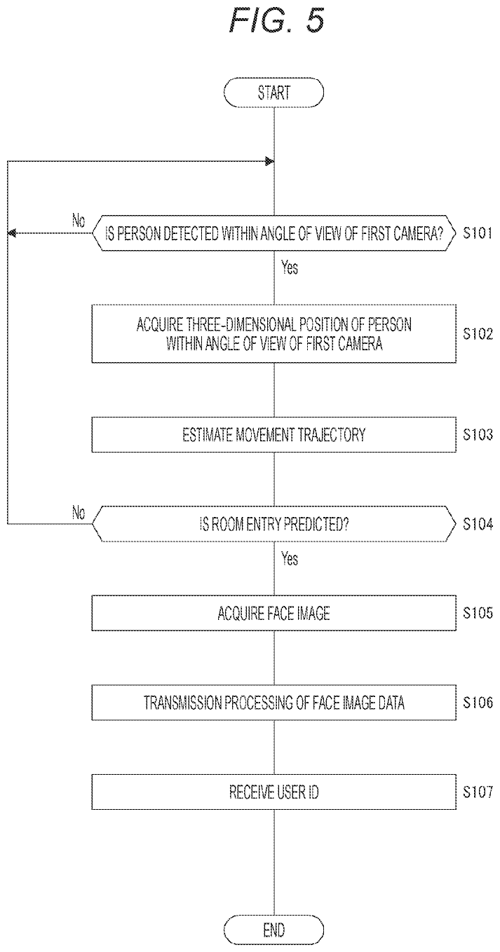

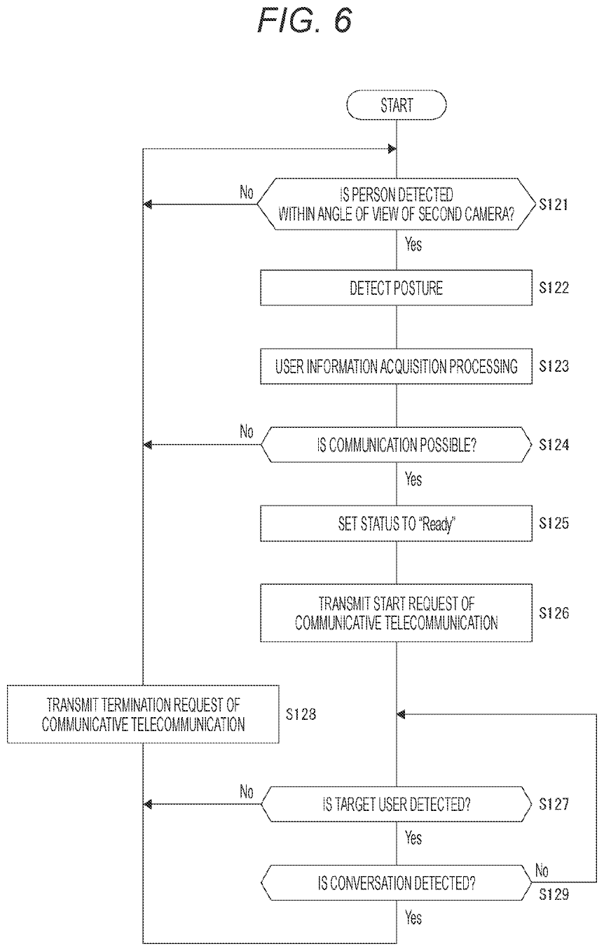

An example of processing executed by the client device 8A included in the client-side system 3 will be described with reference to the flowcharts of FIGS. 5 and 6.

FIG. 5 is an example of processing executed by the client device 8A from a state before the target user enters the room R until the target user is identified as an individual.

In step S101, the control unit 12 of the client device 8A determines whether or not a person is detected within the angle of view of the first camera CA1.

In a case where a person is not detected within the angle of view of the first camera CA1, the processing of step S101 is executed again, and, in a case where a person is detected, the process proceeds to the processing of step S102.

In step S102, the control unit 12 acquires the three-dimensional position of the person detected within the angle of view of the first camera CA1.

In step S103, the control unit 12 performs processing of estimating a movement trajectory of the detected person.

In step S104, the control unit 12 performs room entry determination processing of determining whether or not entry to the room R is predicted.

In a case where it is determined that no entry to the room R is predicted, the control unit 12 returns to the processing of step S101.

On the other hand, in a case where it is determined that entry to the room R is predicted, that is, in a case where it is determined that the detected person can be the target user described above, the control unit 12 acquires a face image of the detected person in step S105. This processing is processing of identifying a region where the image of the face of the person has been captured in the first captured image data.

In step S106, the control unit 12 performs processing of transmitting a face image of the detected person. Specifically, a partial image is generated by cutting out a region where an image of a face is captured from the first captured image data, and the partial image is transmitted to the server-side system 2 as face image data.

As a result, data that is lighter than the first captured image data is transmitted.

Note that the first captured image data may be transmitted as it is to the server-side system 2.

As will be described later, the server-side system 2 that has received the face image data executes processing of identifying the detected person. Information such as a user ID, a name, an employee number, or the like obtained as a result of identifying the person is transmitted to the client device 8.

The control unit 12 receives the individual identifying information such as the user ID transmitted from the server-side system 2 in step S107.

The target user who has entered the room R performs accidental communication with other users by using the client device 8.

For this purpose, the control unit 12 of the client device 8 executes a series of processing illustrated in FIG. 6.

Specifically, in step S121, the control unit 12 determines whether or not a person has been detected within the angle of view of the second camera CA2. The person detected here is basically determined as the target user who has entered the room R immediately before the detection.

However, as illustrated in FIG. 4, in a case where there is a possibility that a plurality of users enters one room R, image recognition processing or the like for identifying which target user is a person detected within the angle of view of the second camera CA2 may be executed.

In a case where a person is not detected within the angle of view of the second camera CA2 in step S121, the control unit 12 executes the processing of step S121 again.

On the other hand, in a case where a person is detected within the angle of view of the second camera CA2 in step S121, the person is set as the target user, and then the processing proceeds to step S122.

In the processing of step S122, the control unit 12 performs processing of detecting the posture of the target user.

Subsequently, in step S123, the control unit 12 acquires user information regarding the target user from the server-side system 2.

In step S124, the control unit 12 performs the communication possibility determination processing for the target user. As a result, it is determined whether or not the target user can perform accidental communication.

In a case where it is determined that the accidental communication cannot be performed, in other words, in a case where the posture of the target user does not take a predetermined posture, in a case where a meeting plan to be started most recently is set, or the like, the control unit 12 returns to the processing of step S121 again.

Note that, in a case where the target user continues to be positioned within the angle of view of the second camera CA2, the user information acquisition processing of step S123 can be executed a plurality of times after each processing of step S121 and step S122 is executed. However, in a case where the processing of acquiring the user information regarding the target user has already been executed, the processing of step S123 may be avoided.

In a case where it is determined that the accidental communication can be performed, for example, in a case where the target user faces the front in a state of being seated on the chair Ch and a meeting plan or the like to be started most recently is not set, the control unit 12 sets the status of the target user to “Ready” in step S125. This processing may be a process of transmitting a request for setting the status to “Ready” to the server-side system 2.

In step S126, the control unit 12 transmits a start request of a communicative telecommunication to the server-side system 2.

In response to this, in the server-side system 2, the partner user to perform accidental communication with the target user is selected, and processing of establishing communicative telecommunication between the target user and the partner user is performed.

In response to this, the control unit 12 executes each processing of steps S127 to $129.

First, in step S127, the control unit 12 determines whether or not the target user is detected within the angle of view of the second camera CA2.

In a case where the target user leaves the seat or leaves the room R, the target user is not detected within the angle of view of the second camera CA2. In such case, the control unit 12 proceeds to step S128 and transmits a termination request of communicative telecommunication to the server-side system 2.

As a result, the control unit 12 returns to the processing of step S121.

On the other hand, in a case where it is determined that the target user is detected within the angle of view of the second camera CA2, the control unit 12 performs processing of detecting a conversation with another person in step S129. As described above, another person is another person other than the partner user selected by the server-side system 2.

In a case where a conversation between the target user and another person is detected, the control unit 12 proceeds to step S128 and transmits a termination request of communicative telecommunication to the server-side system 2.

As a result, the accidental communication with the partner user terminates.

Note that a waiting time of a certain period (about several 10 seconds to several minutes) may be provided at the time of terminating the communication. Then, in a case where the conversation between the target user and another person has not terminated during the standby time, the accidental communication with the partner user may be terminated.

In a case where a conversation with another person is not detected in step S129, the control unit 12 returns to the processing of step S127 again.

That is, each processing of steps S127 and S129 can be rephrased as processing of determining whether or not a condition for terminating the accidental communicative telecommunication is satisfied.

Note that, although not illustrated in FIG. 6, while the accidental communication between the target user and the partner user continues, the control unit 12 transmits the acoustic data based on the speech voice of the target user and the second captured image data of the second camera CA2 to the client device 8B used by the partner user via the telecommunication network 4. At the same time, the control unit 12 executes processing of receiving the captured image data and the acoustic data of the partner user transmitted from the client device 8B and displaying the data on the display device 10 or processing of outputting the data from the speaker 11.

### 3. Processing in Server Device

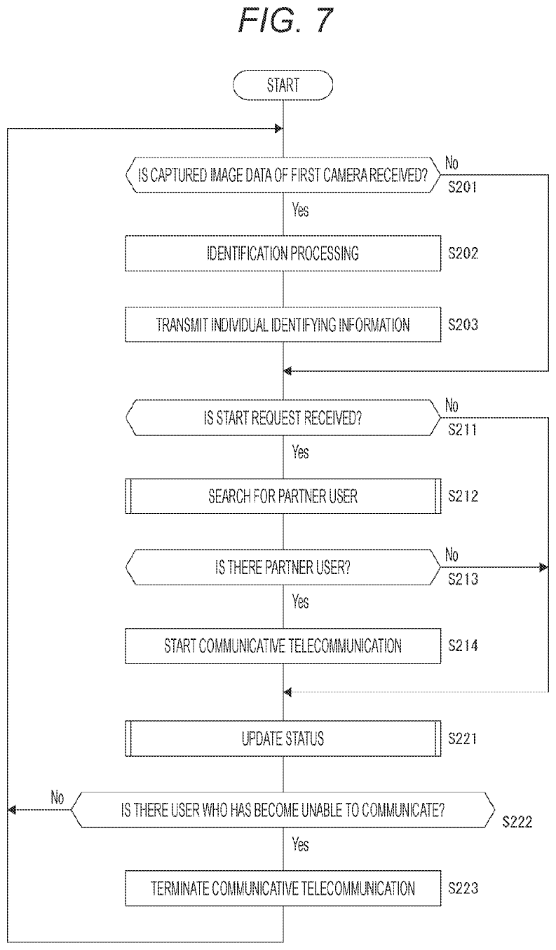

An example of processing executed by the server device 5 included in the server-side system 2 will be described with reference to flowcharts of FIGS. 7, 8, and 9.

A series of processing illustrated in FIG. 7 is executed according to various processing in the client-side system 3.

Specifically, in step S201, the control unit 7 of the server device 5 determines whether or not the first captured image data of the first camera CA1 has been received. The first captured image data is transmitted from the client device 8A, for example, in a case where a person is detected within the angle of view of the first camera CA1 and it is determined that the person is likely to enter the room R. Therefore, the control unit 7 of the server device 5 acquires the first captured image data as the individual identifying information in a case where a certain person is likely to enter the room R.

In a case where it is determined that the first captured image data has been received, in step S202, the control unit 7 executes identification processing for identifying the person (target user) captured in the first captured image data. In this processing, as described above, information for performing individual identification, such as first captured image data, is used.

In step S203, the control unit 7 that has completed the identification processing transmits the individual identifying information as result information of the identification processing to the client-side system 3.

In a case where it is determined in step S201 that the first captured image data has not been received, or after the transmission processing in step S203 is completed, the control unit 7 determines in step S211 whether or not a start request of communicative telecommunication has been received.

In a case where it is determined that the start request has been received, the control unit 7 performs processing of searching for a partner user of the target user in step S212.

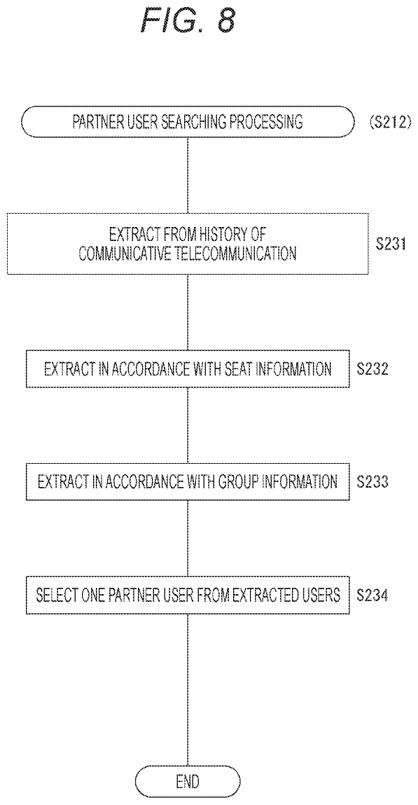

An example of the partner user search processing will be described with reference to FIG. 8.

In the partner user search processing, first, in step S231, the control unit 7 performs processing of extracting a user who is a candidate for the partner user on the basis of the history of the communicative telecommunication. For example, a user who has most recently performed accidental communicative telecommunication with the target user, a user who has frequently performed accidental communicative telecommunication with the target user, or the like is extracted.

Next, in step S232, the control unit 7 extracts a user as a candidate for the partner user according to the seat information.

Subsequently, in step S233, the control unit 7 extracts users that are candidates for the extracted partner user in accordance with, for example, the group information.

That is, in steps S232 and S233, the control unit 7 extracts users that are candidates for the partner user in accordance with the relationship information regarding the target user.

Finally, in step S234, the control unit 7 selects one user as a partner user from among the users extracted so far.

Here, various methods for selecting one user can be considered. For example, selection may be made with emphasis on the history information, selection may be made with emphasis on the seat information, or selection may be made with emphasis on the group information. Furthermore, all the processing of respective steps S231 to S233 may not be performed.

Note that there is a case where no user as a candidate for the partner user is extracted even when the series of processing illustrated in FIG. 8 is executed. In such case, it is not necessary to select the partner user in step S234.

The description returns to FIG. 7.

In step S213, the control unit 7 that has completed the partner user search processing determines whether or not the partner user has been selected.

In a case where the partner user has been selected, in step S214, the control unit 7 performs processing of starting communicative telecommunication between the client device 8A used by the target user and the client device 8B used by the partner user. As a result, the target user does not designate the partner user, and the partner user matching the predetermined condition is automatically selected, and the accidental communication is started.

In a case where it is determined in step S211 that the start request of communicative telecommunication has not been received, in a case where it is determined in step S213 that the partner user has not been selected, or after the processing in step S214 is completed, the control unit 7 executes the status update processing in step S221.

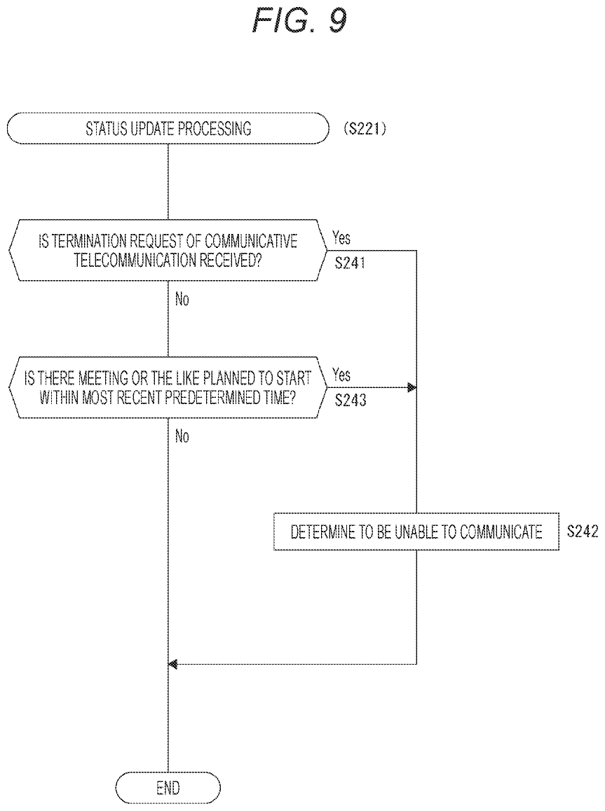

An example of the status update processing will be described with reference to FIG. 9.

In step S241, the control unit 7 determines whether or not a termination request of communicative telecommunication has been received. The termination request is transmitted from the client device 8A or the client device 8B, for example, in a case where a conversation between the target user or the partner user and another person is detected or the like.

In a case where it is determined that the termination request has been received, the control unit 7 determines in step S242 that communication is impossible, and updates the status of the target user or the partner user using the client device 8 that has transmitted the termination request from “Ready” to “Not Ready”.

In a case where it is determined that the termination request has not been received, in step S243, the control unit 7 determines whether or not there is a plan such as a meeting or the like for which start time is set within the most recent predetermined time. In a case where there is a corresponding plan, the control unit 7 updates the status in step S242.

On the other hand, in a case where it is determined in step S241 that the termination request has not been received and there is no corresponding plan or the like, the control unit 7 terminates the status update processing illustrated in FIG. 9.

Note that each processing illustrated in FIG. 9 is performed for all users who have started communicative telecommunication.

The description returns to FIG. 7.

After completion of the status update processing, in step S222, the control unit 7 determines whether or not there is a user who has become unable to communicate, that is, a user whose status has been updated to “Not Ready”.

In a case where the corresponding user exists, in step S223, the control unit 7 terminates the communicative telecommunication established between the corresponding user and the partner user.

Note that, when the communicative telecommunication is terminated, a termination notification may be given to the target user and the partner user. The termination notification is executed, for example, by the termination control unit 45 of the control unit 7.

On the other hand, in a case where there is no corresponding user, the control unit 7 returns to step S201 again.

That is, the control unit 7 repeatedly executes each determination processing of steps S201, S211, and S222, and executes a series of processing corresponding to each determination processing in accordance with a result of the determination processing.

### 4. Another Example of Processing in Server Device

In the above example, an example has been described in which one partner user is selected for the target user, and one-to-one accidental communication is started between the target user and the partner user.

In this example, a community is formed including the target user and a plurality of partner users, and accidental communication of three or more persons can be started.

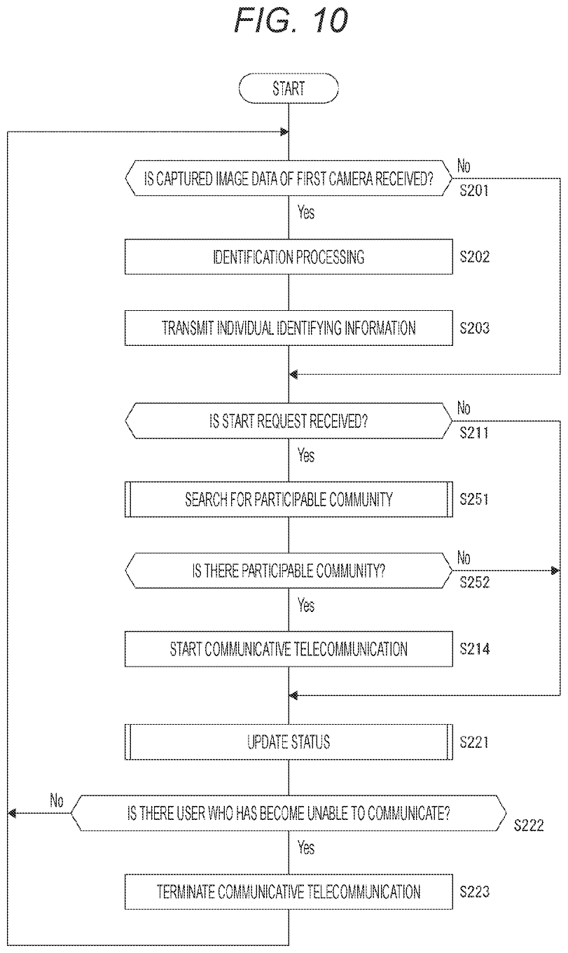

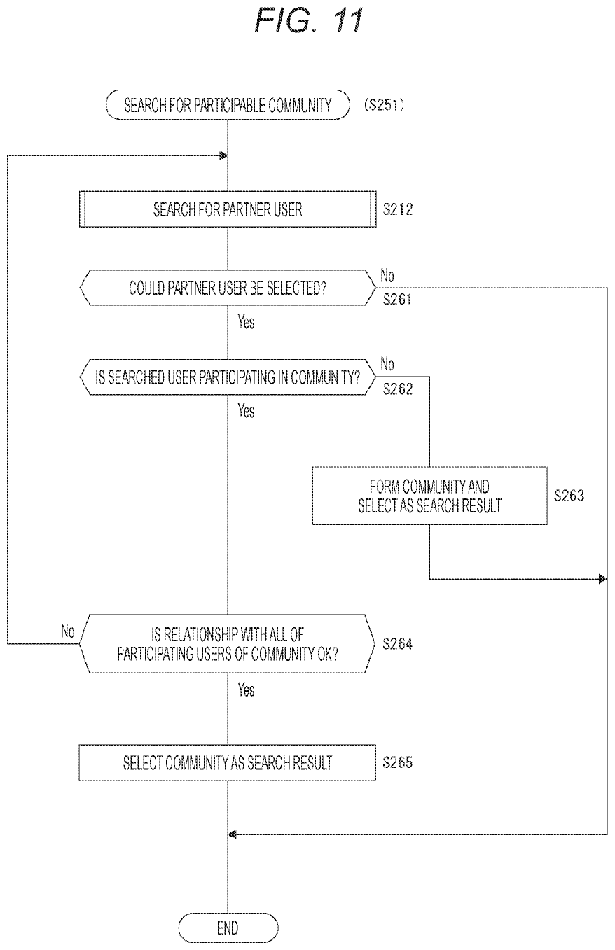

Specifically, a processing example executed by the server device 5 will be described with reference to FIGS. 10 and 11. Note that processing similar to the processing illustrated in FIGS. 7 and 8 are denoted by the same step numbers, and description thereof will be omitted as appropriate.

In step S201 of FIG. 10, the control unit 7 determines whether or not the first captured image data has been received. In a case where it is determined that the first captured image data has been received, processing similar to that in the above example is performed, and thus description thereof is omitted.

After it is determined that the first captured image data has not been received or after the processing of step S203 is completed, the control unit 7 determines whether or not a start request of communicative telecommunication has been received in step S211.

In a case where it is determined that the start request of communicative telecommunication has been received, the control unit 7 performs processing of searching for a participable community in step S251.

An example of the participable community search processing will be described with reference to FIG. 11.

First, in step S212, the control unit 7 performs processing of searching for a partner user of the target user. Details of this processing have been described with reference to FIG. 8, and thus, detailed description thereof will be omitted.

In step S261, the control unit 7 that has completed the partner user search processing determines whether or not one partner user has been selected.

In a case where it is determined that one partner user cannot be selected, it is determined that there is no participable community, and the processing illustrated in FIG. 11 is terminated.

On the other hand, in a case where it is determined that one partner user can be selected, in step S262, the control unit 7 determines whether or not the selected partner user is participating in the community, that is, whether or not the partner user is in communicative telecommunication with one or more other users.

In a case where it is determined that the partner user is not participating in the community, in step S263, the control unit 7 forms a community with the target user and the partner user selected in step S212, selects the community as a search result, and terminates the series of processing of FIG. 11.

In a case where it is determined that the partner user is participating in the community, in step S264, the control unit 7 determines whether or not the target user may be added to the community on the basis of the relationship information between all the participating users and the target user for the community.

For example, in a case where all the participating users and the target user belong to the same department, a case where the participating user and the target user are employees who have joined the company in the same time, or the like, it is determined that the target user may be added to the community.

In a case where it is determined that the target user may be added, in step S265, the control unit 7 selects the community as a search result and completes the series of processing of FIG. 11.

On the other hand, in a case where there is a user having a weak relationship with the target user among the users participating in the community, it is determined that it is not preferable to add the target user to the community.

In such case, the control unit 7 returns to step S212 and searches for another partner user.

Then, each processing of steps S261 to S264 is similarly performed for another partner user, and in a case where no another partner user has been searched, it is determined that there is no participable community, and the processing illustrated in FIG. 11 is terminated.

The description returns to FIG. 10.

After completing the processing of searching for the participable community in step S251, the control unit 7 determines whether or not the participable community can be searched for in step S252. In a case where there is no participable community, the processing returns to step S221. In such case, the accidental communicative telecommunication for the target user is not started.

On the other hand, in a case where it is determined that there is a participable community, the control unit 7 proceeds to step S214, and accidental communicative telecommunication with each member of the community is started.

As a result, communication such as a water-cooler conversation with many people is performed.

Each processing in and after step S221 executed in a case where it is determined in step S211 that the start request of communicative telecommunication has not been received or executed after step S214 is completed is similar to the processing in FIG. 7, and thus the description thereof will be omitted.

### 5. Modifications

In the above-described example, an example has been described in which the accidental communication for the target user is immediately started in a case where a partner user or a participable community is found.

However, in some cases, it may be better to start accidental communication after confirmation of the target user.

Therefore, in the present modification, the start control unit 44 of the control unit 7 of the server device 5 performs processing for confirming whether or not communicative telecommunication may be started.

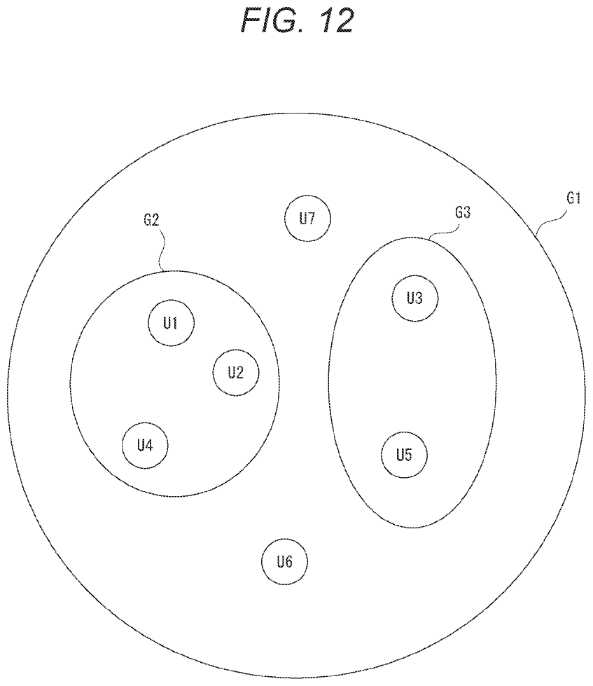

FIG. 12 illustrates an example of the relationship among seven users U1 to U7. The three users U1, U2, and U4 belong to a large group G1 and also belong to a small group G2. That is, the users U1, U2, and U4 are users having a very strong relationship with each other.

On the other hand, although both the user U1 and the user U3 belong to the same group G1, the user U1 belongs to a small group G2, and the user U2 belongs to a small group G3. That is, the user U1 and the user U3 are users having a weaker relationship than the user U1 and the user U2.

In a case where the target user is the user U1 and the partner user selected by the partner user selection processing is the user U2, accidental communication is generated without requesting the target user U1 for confirmation.

On the other hand, in a case where the target user is the user U1 and the partner user selected by the partner user selection processing is the user U3, processing for requesting the target user U1 for confirmation, for example, processing of allowing selection as to whether or not to start communicative telecommunication, or the like is executed.

As a result, it is possible to suppress the accidental communication from semi-forcibly occurring between users who usually do not communicate with each other.

Furthermore, even for users having a strong relationship, such as the user U1 and the user U2, the control unit 7 may perform processing of allowing selection as to whether or not to start the communicative telecommunication in a case where there is a hierarchical relationship in managerial positions or the like.

Other modifications will be described.

The user information acquisition unit 25 and the communication possibility determination unit 26 may be provided in the control unit 7 of the server device 5.

For example, the server device 5 may acquire user information such as schedule information and execute the communication possibility determination processing using the information.

Although the example in which the user is identified as an individual on the basis of the captured image data has been described, the individual identification may be performed using an authentication result of fingerprint authentication or vein authentication.

For example, there may be a case where authentication using an employee ID is performed by holding up an ID card such as an employee ID at the time of entering the room R to permit room entry, or a case where vein authentication is performed by holding a palm of the hand to permit room entry. In such case, since the individual identification has already been performed by the authentication processing at the time of room entry, the identification processing unit 42 can perform the individual identification of the person who has entered the room R only by acquiring the authentication result at the time of room entry.

In addition to this, individual identification may be performed using a wireless tag worn by a person who has entered the room.

In the above-described example, the room R partitioned by a wall or the like is taken as an example of the specific space, but the present technology can also be applied to a specific space not partitioned by a wall or the like. In such case, it is only required that the first camera CAL detects a person who is likely to approach a specific space and, in a case where such a person can be detected, the first camera CA1 transmits the captured image data to the server-side system 2 and causes the server-side system 2 to execute the individual identification processing.

Furthermore, the specific space may be a specific space provided at the home of the target user. In such case, there is a case where the partner user having a weak relationship with the target user cannot see the inside of the house.

Therefore, by replacing the background portion with another image in accordance with the relationship with the target user, the inside of the home of the target user can be prevented from being viewed by the partner user.

Furthermore, in a case where a person other than the target user, such as a family member or the like appears within the angle of view of the second camera CA2, a blurring process, a mosaic process, or the like may be performed on the appeared person. Furthermore, whether or not these process processing can be executed may be determined in accordance with the strength of the relationship between the target user and the partner user.

In FIG. 4, an example has been described in which three target spaces S are provided in one room R, and each target space S is partitioned by a wall.

As a method other than this, a plurality of target users may be allowed to enter one room R, and the target spaces S of the target users may be common.

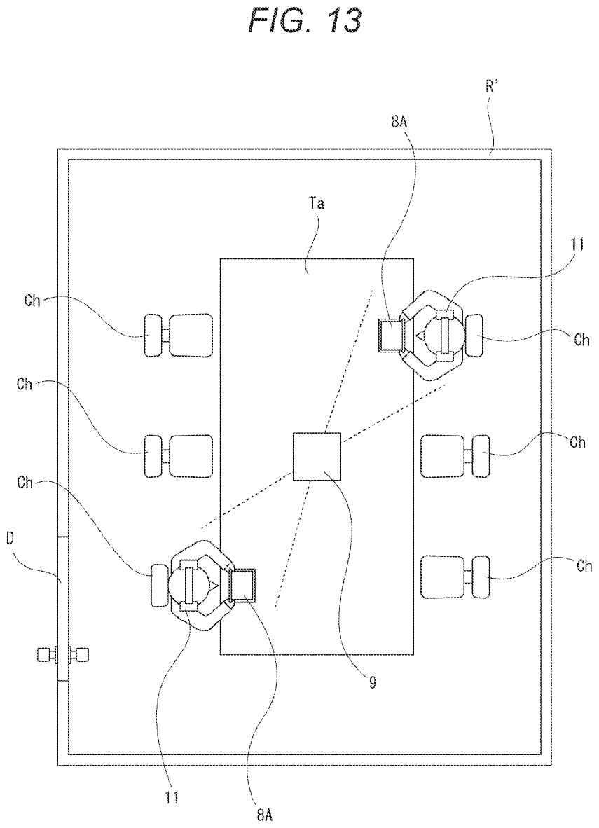

An example is illustrated in FIG. 13.

The room R′ is provided as one room in which the door D is disposed, and the inside is formed as one target space S.

A table Ta is installed at the center of the room R′, and the microphone 9 that can be used by a large number of people are installed substantially at the center of the table Ta.

A plurality of chairs Ch is prepared on the table Ta so that a plurality of people can sit on the chairs. The microphone 9 is a beamforming microphone or the like capable of individually collecting speech voice of a plurality of target users.

Each target user wears headphones as the speaker 11 while holding a tablet terminal as the client device 8A including the display device 10 and the control unit 12. The headphones are connected to the tablet terminal. The image of the partner user transmitted from the client device 8B is displayed on the display unit of the tablet, and the speech voice and the like of the partner user are output from the headphones via the tablet.

The speech voice of the target user is collected by the beamforming microphone so as not to be mixed with the speech voice with another target user, and delivered to the partner user.

Each target user can listen to the voice of the partner user without worrying about the speech voice of another target user via headphones, earphones, or the like, and the partner user can listen to only the speech voice of one target user.

By using the configuration as illustrated in FIG. 13, it is not necessary to partition the space so that the target space S is independently formed, and space saving can be achieved.

In the flowchart of FIG. 6, an example has been described in which, in a case where it is determined in the communication possibility determination processing of step S124 that the target user cannot perform communication, the control unit 12 returns to the processing of step S121 again.

However, in a case where the target user has a plan to start within the most recent predetermined time, and the plan is an online meeting or the like via the network, the control unit 12 may execute processing of connecting to a meeting room of the planned online meeting or the like instead of returning to the processing of step S121. As a result, the user can participate in the online meeting from room R or the like without moving to another place. Furthermore, since the user does not need to manually perform an operation of connecting to the meeting room at this time, convenience can be improved.

### 6. Computer Device

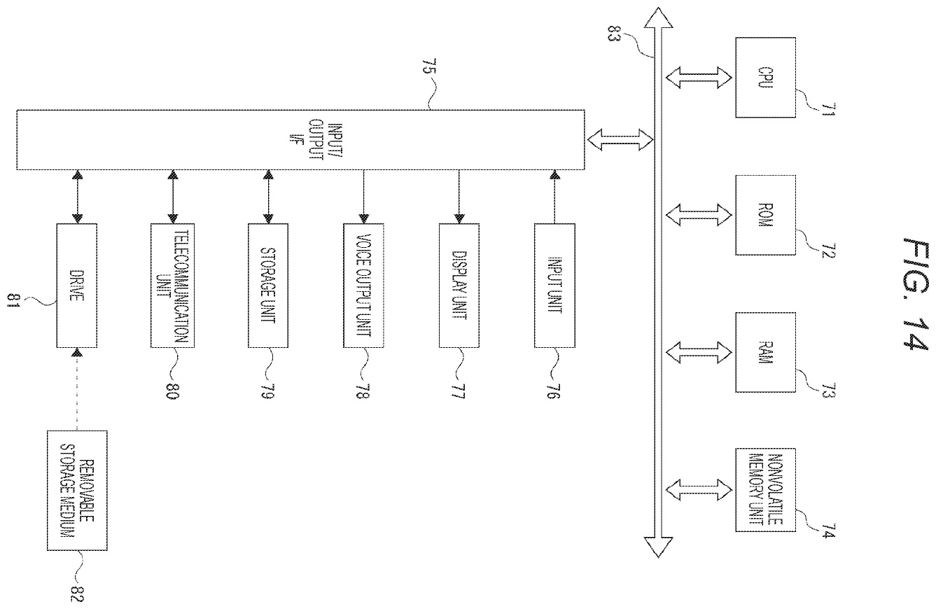

Various information processing devices such as the server device 5, the user DB 6, and the client device 8 (8A, 8B) are computer devices including an arithmetic processing unit. A configuration example of the computer device will be described with reference to FIG. 14.

A CPU 71 of the computer device functions as the arithmetic processing unit which performs the above-described various type of processing, and executes the various type of processing in accordance with a program stored in a nonvolatile memory unit 74 such as a ROM 72 or, for example, an electrically erasable programmable read-only memory (EEP-ROM), or a program loaded from a storage unit 79 to a RAM 73. The RAM 73 also appropriately stores data and the like necessary for the CPU 71 to execute the various types of processing.

The CPU 71, the ROM 72, the RAM 73, and the nonvolatile memory unit 74 are connected to one another via a bus 83. An input/output interface (I/F) 75 is also connected to the bus 83.

An input unit 76 including an operation element and an operation device is connected to the input/output interface 75.

For example, as the input unit 76, various types of operation elements and operation devices such as a keyboard, a mouse, a key, a dial, a touch panel, a touch pad, a remote controller, and the like are assumed.

An operation by a user U is detected by the input unit 76, and a signal corresponding to the input operation is interpreted by the CPU 71.

Note that the second camera CA2 and the microphone 9 described above are an aspect of the input unit 76.

Furthermore, a display unit 77 including an LCD, an organic EL panel, or the like, and a voice output unit 78 including a speaker or the like are connected to the input/output interface 75 integrally or separately.

The display unit 77 is a display unit that performs various displays, and includes, for example, a display device provided in a housing of a computer device, a separate display device connected to the computer device, or the like.

The display unit 77 executes display of an image for various types of image processing, a moving image to be processed, and the like on a display screen on the basis of an instruction from the CPU 71. In addition, the display unit 77 displays various types of operation menus, icons, messages, and the like, that is, displays as a graphical user interface (GUI) on the basis of an instruction from the CPU 71.

In some cases, the storage unit 79 including a hard disk, a solid-state memory, or the like, and a telecommunication unit 80 including a modem or the like are connected to the input/output interface 75.

The telecommunication unit 80 executes telecommunication processing via a transmission path such as the Internet or the like or performs wired/wireless telecommunication with various types of devices, telecommunication using bus telecommunication, or the like.

A drive 81 is also connected to the input/output interface 75 as necessary, and a removable storage medium 82 such as a magnetic disk, an optical disk, a magneto-optical disk, or a semiconductor memory is appropriately mounted.

A data file such as a program or the like used for each processing can be read from the removable storage medium 82 by the drive 81. The read data file is stored in the storage unit 79, and images and voice included in the data file are output by the display unit 77 and the voice output unit 78. Furthermore, a computer program and the like read from the removable storage medium 82 are installed in the storage unit 79 as necessary.

In this computer device, for example, software for processing of the present embodiment can be installed via network communication by the telecommunication unit 80 or the removable storage medium 82. Alternatively, the software may be stored in advance in the ROM 72, the storage unit 79, or the like.

The CPU 71 executes information processing and telecommunication processing necessary in the various types of information processing devices including the above-described arithmetic processing unit by executing the processing operations on the basis of the various programs.

Note that the information processing device is not limited to a configuration of a single computer device as illustrated in FIG. 14 and may be configured by systematizing a plurality of computer devices. The plurality of computer devices may be systematized by a local area network (LAN) or the like, or may be disposed in a remote place by a virtual private network (VPN) or the like using the Internet or the like. The plurality of computer devices may include a computer device as a server group (cloud) that can be used by a cloud computing service.

### 7. Conclusion

As described in each of the examples described above, the information processing device serving as the server device 5 included in the server-side system 2 includes: the individual identifying information acquisition unit 41 that acquires the individual identifying information regarding the target user from another information processing device (from the client device 8); the partner user selection unit 43 that selects, in a case where the target user is determined to be able to communicate on the basis of the user information regarding the target user identified as an individual, the partner user who is the communication partner of the target user from among other users determined to be able to communicate; and the start control unit 44 that starts the communicative telecommunication between the target user and the partner user.

The user information is, for example, schedule information, posture information, or the like. By determining whether or not communication is possible on the basis of the user information, it is possible to automatically select a partner user and start communicative telecommunication in a case where a state of being able to communicate is achieved.

As a result, the user can accidentally generate the interaction instead of designating the partner user by himself/herself to perform the interaction. Therefore, it is possible to perform easy communication such as a chat that occurs at the time of a business break with a distant partner user.

Furthermore, the amount of operation performed by the user to perform communicative telecommunication with other users can be reduced, and the burden on the user can be reduced.

As described in the description of the system configuration and FIG. 7, the individual identifying information may be information used for processing of identifying the target user.

The individual identifying information is, for example, information used for processing of uniquely identifying the user, such as captured image data or fingerprint information regarding the target user.

The server device 5 manages various types of information regarding the user, and the server device 5 executes the individual identification processing based on the individual identifying information on the basis of these types of information. Therefore, it is not necessary to transmit various types of information regarding the user held by the server device 5 to another information processing device, which is preferable from the viewpoint of privacy protection.

As described in the description of the system configuration and FIG. 7, the individual identifying information is captured image data (first captured image data or the like) obtained by capturing an image of the target user, and the server device 5 may include the identification processing unit 42 that identifies the target user by performing image processing on the captured image data.

In the client-side system 3, imaging is performed with the target user as a subject. Then, the captured image data is transmitted from the client device 8 to the server device 5, whereby the server device 5 can perform image recognition processing and identify the target user.

As a result, the client-side system 3 can transmit information that can identify the target user only by providing the camera (the first camera CA1 or the second camera CA2) for obtaining the captured image data. Therefore, it is not necessary for the client-side system 3 to include a special device such as a device for acquiring a fingerprint, and it is easy to configure the system.

As described in the system configuration and the description of FIG. 3, the individual identifying information may be information of a result of identifying the target user.

The individual identifying information is, for example, information such as a name, an employee number, and a user ID of the target user.

For example, it is only required that, by the processing of identifying an individual performed in the client device 8, the individual identifying information acquisition unit 41 acquires the individual identifying information as a processing result. As a result, the burden of various types of processing for starting communicative telecommunication can be distributed to a plurality of information processing devices.

As described in the system configuration and the description of FIG. 6, the user information may be schedule information regarding the target user.

As a result, whether or not communication can be performed is determined on the basis of the schedule information set by the user.

Therefore, in a case where a meeting plan or the like is set most recently such as a few minutes later or the like, it is possible to prevent communicative telecommunication for causing accidental communication from being started.

As described in the system configuration and the description of FIG. 6, in a case where there is a plan whose start time is set within a predetermined time from the current point of time, the target user may be determined to be unable to communicate.

As a result, it is possible to start accidental communication in a case where a plan such as a meeting is not set within a predetermined time.

Therefore, it is possible to prevent the user from failing to participate in a plan such as a meeting plan or the like.

As described in the system configuration and the description of FIG. 2, the user information may be posture information regarding the target user.

As a result, for example, the selection processing of the partner user and the start processing of the communicative telecommunication are performed with the user having a specific posture as a trigger.

Therefore, since it is possible to objectively and automatically detect that the user is ready for the interaction, the user does not need to perform a specific operation, and convenience can be improved.

As described in the system configuration and the description of FIG. 6, the target user may be determined to be able to communicate in a case where a predetermined posture of the target user has been detected.

The user can start accidental communication only by taking a predetermined posture.

Therefore, user convenience can be improved.

As described in the system configuration and the description of FIG. 9, the user information is information indicating whether or not the target user is in a state of being spoken to by another person, and in a case where the target user has been determined to be in a state of being spoken to by another person, the target user may be determined to be unable to communicate.

As a result, it is possible to avoid a situation where, for example, it is determined that communication is possible during a conversation with another person at a short distance and different communication needs to be performed at the same time.

As described in the system configuration and the description of FIG. 8, the partner user selection unit 43 may select the partner user on the basis of the relationship information between the target user and other users.

The relationship information is, for example, information regarding a positional relationship of seats in a company, information regarding whether or not being involved in the same project, information regarding whether or not being in the same department, information regarding a frequency of communication, or the like.

On the basis of such relationship information of the users, the user having a daily conversation is easily selected as the partner user. Thus, it is possible to cause natural accidental communication.

As described in the system configuration and the description of FIG. 2, the relationship information may be information regarding the relationship between the organization to which the target user belongs and the organization to which other users belong.

The relationship of the organization is, for example, information regarding whether or not being involved in the same project, information regarding whether or not being in the same department, or the like. Alternatively, it may be information such as whether or not the users are employees who have joined the company in the same time or the like.

On the basis of such relationship information, it is possible to cause accidental communication close to communication actually occurring in the company.

As described in the system configuration and the description of FIG. 3, the relationship information may be information regarding a history of communicative telecommunication between the target user and other users.

For example, a user having a high frequency of communicative telecommunication with the target user can be selected as the partner user.

As a result, it is possible to increase the possibility of performing communicative telecommunication with a user who is familiar for the target user as a partner user.

As described in the modifications, the start control unit 44 may perform processing for allowing the target user to select whether or not to start communicative telecommunication.

As a result, it is possible to prevent the communicative telecommunication from being automatically started against the intention of the target user.

For example, in some cases, a user having a low relationship with the target user or a user who is not easy for the target user to communicate with is selected as the partner user. In such case, by allowing the target user to select whether or not to start the communicative telecommunication, it is possible to prevent inappropriate communication from being performed.

As described in the system configuration and the description of FIG. 3, the server device 5 may include the termination control unit 45 that terminates the communicative telecommunication between the target user and the partner user.

As a result, the communicative telecommunication can be automatically terminated without operation by the target user or the partner user.

Therefore, user convenience can be improved.

As described in the system configuration and the description of FIGS. 6, 7, and 9, the user information is information indicating whether or not the target user is in a state of being spoken to by another person, and the termination control unit 45 may terminate the communicative telecommunication on the basis of the user information.

As a result, in a case where the target user is spoken to in the real space, the communicative telecommunication can be automatically terminated, and the operation burden on the user can be reduced.

Note that the state in which the user is spoken to by another person includes not only a state in which the user is spoken to by another person in the real space but also a state in which a conversation with another person is started using a mobile phone.

As described in the description of FIG. 7, the termination control unit 45 may notify that the communicative telecommunication is to be terminated.

For example, the termination of the communicative telecommunication is notified to both the target user and the partner user.

As a result, it is possible to prevent discomfort that the conversation is suddenly broken off from being given to the partner user.

As described in the system configuration and the description of FIG. 7, the individual identifying information acquisition unit 41 may acquire the individual identifying information in a case where it is determined that the target user intrudes into (enters the room) the specific space (such as room R).

For example, the first camera CAL is disposed at an entrance of a specific room provided as a specific space, and a person who is going to enter (intrude into) the specific room can be specified from persons passing through the vicinity of the entrance by analyzing captured image data of the first camera CA1.

As a result, it is possible to narrow down the users who are the acquisition targets of the individual identifying information, and thus, it is possible to reduce the processing load.

As described in the modifications, in a case where the plan intends to use communicative telecommunication, the start control unit 44 may start communicative telecommunication for the plan intended.

As a result, it is possible to automatically participate in the planned meeting instead of providing the accidental communication to the user for whom the planned meeting or the like is set.

Therefore, it is possible to reduce the user's operation burden and the like.

An information processing method in the present technology is executed by a computer device and includes : individual identifying information acquisition processing of acquiring individual identifying information regarding a target user from another information processing device; partner user selection processing of selecting, in a case where the target user is determined to be able to communicate on the basis of user information regarding the target user identified as an individual, a partner user who is a communication partner of the target user from among other users determined to be able to communicate; and start control processing of starting communicative telecommunication between the target user and the partner user.

A program in the present technology is configured to be executed by an arithmetic processing device and includes: an individual identifying information acquisition function of acquiring individual identifying information regarding a target user from another information processing device; a partner user selection function of selecting, in a case where the target user has been determined to be able to communicate on the basis of user information regarding the target user identified as an individual, a partner user who is a communication partner of the target user from among other users determined to be able to communicate; and a start control function of starting communicative telecommunication between the target user and the partner user.

Such program can be recorded in advance in a hard disk drive (HDD) as a recording medium built in a device such as a computer device, a ROM in a microcomputer having a CPU, or the like. Alternatively, the program can be temporarily or permanently stored (recorded) in a removable storage medium such as a flexible disk, a compact disc read only memory (CD-ROM), a magneto optical (MO) disk, a digital versatile disc (DVD), a Blu-ray disc (registered trademark), a magnetic disk, a semiconductor memory, or a memory card. Such a removable storage medium can be provided as what is called package software.

Furthermore, such a program can be installed from the removable storage medium into a personal computer or the like, or can be downloaded from a download site via a network such as a local area network (LAN) or the Internet.

Note that the effects described in the present specification are merely examples and are not limited, and other effects may be provided.

Furthermore, each example described above may be combined in any way, and the above-described various functions and effects may be obtained even in a case where various combinations are used.

### 8. Present Technology

The present technology can also adopt the following configurations.

(1)

An information processing device including:

an individual identifying information acquisition unit that acquires individual identifying information regarding a target user from another information processing device;

a partner user selection unit that selects, in a case where the target user is determined to be able to communicate on the basis of user information regarding the target user identified as an individual, a partner user who is a communication partner of the target user from among other users determined to be able to communicate; and

a start control unit that starts communicative telecommunication between the target user and the partner user.

(2)

The information processing device according to (1), in which

the individual identifying information is information used for processing of identifying the target user.

(3)

The information processing device according to (2), in which

the individual identifying information is captured image data obtained by capturing an image of the target user, and

the information processing device further includes an identification processing unit that identifies the target user by performing image processing on the captured image data.

(4)

The information processing device according to (1), in which

the individual identifying information is information of a result of identifying the target user.

(5)

The information processing device according to any one of (1) to (4), in which

the user information is schedule information regarding the target user.

(6)

The information processing device according to (5), in which,

in a case where there is a plan whose start time is set within a predetermined time from a current point of time, the target user is determined to be unable to communicate.

(7)

The information processing device according to any one of (1) to (6), in which

the user information is posture information regarding the target user.

(8)

The information processing device according to (7), in which,

in a case where a predetermined posture has been detected for the target user, the target user is determined to be able to communicate.

(9)

The information processing device according to any one of (1) to (8), in which

the user information is information indicating whether or not the target user is in a state of being spoken to by another person, and,

in a case where the target user is determined to be in the state of being spoken to by another person, the target user is determined to be unable to communicate.

(10)

The information processing device according to any one of (1) to (9), in which

the partner user selection unit selects the partner user on the basis of relationship information between the target user and the other users.

(11)

The information processing device according to (10), in which

the relationship information is information regarding a relationship between an organization to which the target user belongs and an organization to which the other users belong.

(12)

The information processing device according to any one of (10) to (11), in which

the relationship information is information regarding a history of communicative telecommunication between the target user and the other users.

(13)

The information processing device according to any one of (1) to (12), in which

the start control unit performs processing for allowing the target user to select whether or not to start the communicative telecommunication.

(14)

The information processing device according to any one of (1) to (13), further including

a termination control unit that terminates the communicative telecommunication for the target user and the partner user.

(15)

The information processing device according to (14), in which

the user information is information indicating whether or not the target user is in a state of being spoken to by another person, and

the termination control unit terminates the communicative telecommunication on the basis of the user information.

(16)

The information processing device according to (14) or (15), in which

the termination control unit notifies that the communicative telecommunication is to be terminated.

(17)

The information processing device according to any one of (1) to (16), in which

the individual identifying information acquisition unit acquires the individual identifying information in a case where the target user is determined to intrude into a specific space.

(18)

The information processing device according to (6), in which,

in a case where the plan intends to use communicative telecommunication, the start control unit starts communicative telecommunication for the plan intended.

(19)

An information processing method that makes a computer device execute:

individual identifying information acquisition processing of acquiring individual identifying information regarding a target user from another information processing device;

partner user selection processing of selecting, in a case where the target user has been determined to be able to communicate on the basis of user information regarding the target user identified as an individual, a partner user who is a communication partner of the target user from among other users determined to be able to communicate; and

start control processing of starting communicative telecommunication between the target user and the partner user.

(20)

A program configured to make an arithmetic processing device execute:

an individual identifying information acquisition function of acquiring individual identifying information regarding a target user from another information processing device;

a partner user selection function of selecting, in a case where the target user has been determined to be able to communicate on the basis of user information regarding the target user identified as an individual, a partner user who is a communication partner of the target user from among other users determined to be able to communicate; and

a start control function of starting communicative telecommunication between the target user and the partner user.

### REFERENCE SIGNS LIST

5 Server device (Information processing device)
8, 8A, 8B Client device (Another information processing device)
41 Individual identifying information acquisition unit
42 Identification processing unit
43 Partner user selection unit
44 Start control unit
45 Termination control unit

1. An information processing device comprising:
an individual identifying information acquisition unit that acquires individual identifying information regarding a target user from another information processing device;
a partner user selection unit that selects, in a case where the target user has been determined to be able to communicate on a basis of user information regarding the target user identified as an individual, a partner user who is a communication partner of the target user from among other users determined to be able to communicate; and
a start control unit that starts communicative telecommunication between the target user and the partner user.

2. The information processing device according to claim 1, wherein
the individual identifying information is information used for processing of identifying the target user.

3. The information processing device according to claim 2, wherein
the individual identifying information is captured image data obtained by capturing an image of the target user, and
the information processing device further comprises an identification processing unit that identifies the target user by performing image processing on the captured image data.

4. The information processing device according to claim 1, wherein
the individual identifying information is information of a result of identifying the target user.

5. The information processing device according to claim 1, wherein
the user information is schedule information regarding the target user.

6. The information processing device according to claim 5, wherein,
in a case where there is a plan whose start time is set within a predetermined time from a current point of time, the target user is determined to be unable to communicate.

7. The information processing device according to claim 1, wherein
the user information is posture information regarding the target user.

8. The information processing device according to claim 7, wherein,
in a case where a predetermined posture has been detected for the target user, the target user is determined to be able to communicate.

9. The information processing device according to claim 1, wherein
the user information is information indicating whether or not the target user is in a state of being spoken to by another person, and,
in a case where the target user has been determined to be in the state of being spoken to by another person, the target user is determined to be unable to communicate.

10. The information processing device according to claim 1, wherein
the partner user selection unit selects the partner user on a basis of relationship information between the target user and the other users.

11. The information processing device according to claim 10, wherein
the relationship information is information regarding a relationship between an organization to which the target user belongs and an organization to which the other users belong.

12. The information processing device according to claim 10, wherein
the relationship information is information regarding a history of communicative telecommunication between the target user and the other users.

13. The information processing device according to claim 1, wherein
the start control unit performs processing for allowing the target user to select whether or not to start the communicative telecommunication.

14. The information processing device according to claim 1, further comprising
a termination control unit that terminates the communicative telecommunication for the target user and the partner user.

15. The information processing device according to claim 14, wherein
the user information is information indicating whether or not the target user is in a state of being spoken to by another person, and
the termination control unit terminates the communicative telecommunication on a basis of the user information.

16. The information processing device according to claim 14, wherein
the termination control unit notifies that the communicative telecommunication is to be terminated.

17. The information processing device according to claim 1, wherein
the individual identifying information acquisition unit acquires the individual identifying information in a case where the target user is determined to intrude into a specific space.

18. The information processing device according to claim 6, wherein,
in a case where the plan intends to use communicative telecommunication, the start control unit starts communicative telecommunication for the plan intended.

19. An information processing method that makes a computer device execute:
individual identifying information acquisition processing of acquiring individual identifying information regarding a target user from another information processing device;
partner user selection processing of selecting, in a case where the target user has been determined to be able to communicate on a basis of user information regarding the target user identified as an individual, a partner user who is a communication partner of the target user from among other users determined to be able to communicate; and
start control processing of starting communicative telecommunication between the target user and the partner user.

20. A program configured to make an arithmetic processing device execute:
an individual identifying information acquisition function of acquiring individual identifying information regarding a target user from another information processing device;
a partner user selection function of selecting, in a case where the target user has been determined to be able to communicate on a basis of user information regarding the target user identified as an individual, a partner user who is a communication partner of the target user from among other users determined to be able to communicate; and
a start control function of starting communicative telecommunication between the target user and the partner user.
